(19) United States
(12) Patent Application Publication
(10) Pub. No.: US 2006/0148311 A1
(43) Pub. Date: Jul. 6, 2006

(54) Sensor

(76) Inventors: Jurgen Tschope, Selm (DE); Sebastian M. Mundry, Ludinghausen (DE); Frank Reiner, Gevelsberg (DE)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/296,791

(22) Filed: Dec. 7, 2005

(30) Foreign Application Priority Data
Dec. 8, 2004 (DE) 202004019050.8

(51) Int. Cl. H01R 11/00

(52) U.S. Cl. 439/502

(57) ABSTRACT

A sensor for devices such as mining machines, shaft-lining supports or extracting plants in underground mining, comprising a sensor device (15) disposed in a casing (11) and scanning measurements or variables and converting them into electric signals, also comprising a connecting element (26) in the form of a plug or socket fixed to the sensor casing (11) and adapted to be coupled to a receiving connection on the device and through which the sensor device (15) is supplied with the measurement or variable, and also comprising a flexible sheathed cable (1) comprising conductors (4) and a sheath (2), the sensor device (15) being electrically connectable via the conductors (4) to an evaluating device, in which the sensor casing (11) comprises a portion (13) with a cable insertion opening (20) to which the sheathed cable (1) is fastened in tension-resistant manner, wherein the conductors (4) are firmly connected through the cable insertion opening to the sensor device (15).

The present invention relates to a sensor for devices such as mining machines, shaft-lining supports, hydraulic systems or extracting plants in underground mining, comprising a sensor device disposed in a casing and scanning measurements or variables and converting them into electric signals, also comprising a connecting element in the form of a plug or socket fixed to the sensor casing and adapted to be coupled to a receiving connection on the device and through which the sensor device is supplied with the measurement or variable, and also comprising a flexible sheathed cable comprising conductors and a sheath, the sensor device being electrically connectable via the conductors to an evaluating device.

A sensor in accordance with the preamble and in the form of a pressure pick-up has been proposed in DE 202 19 732 U1. In the case of the pressure pick-up in accordance with the preamble, the sensor device is a ceramic pressure element disposed in a recess in the back of the plug or connecting element, which has an extension surrounding the recess and sealingly inserted into the sensor casing and fastened therein by a screw cap. The pressure element comprises an amplifier circuit on a circuit board, bonded in sealing compound, and an auxiliary or additional electronic unit fastened to the back of the plug or connecting element. The back of the sensor casing remote from the connecting element has an electric plug connection accessible from the outside and adapted to be coupled via a suitable cable connector to a sheathed cable used in underground mining. Since the cable connector must be connected in tension-resistant manner to the sheath of the sheathed cable, the pressure pick-up according to the preamble needs a relatively large amount of assembly space at the connection to the underground device, since the sensor casing and the cable connector are axially aligned in series.

The required space is still relatively large if the cable connector on the sheathed cable is a right-angle plug, as described for example in DE 296 14 501 U1.

It is an aim of the invention is to devise a sensor which takes up minimum room for assembly or when assembled on the underground device, such as a hydraulic connection to mining machines, shaft-lining supports or the like.

Accordingly the present invention is directed to a sensor as described in the opening paragraph of the present specification, wherein the sensor casing comprises a portion with a cable insertion opening to which the sheathed cable is fastened in tension-resistant manner, wherein the conductors are firmly connected through the cable insertion opening to the sensor device. In the sensor in accordance with the invention, therefore, the sheathed cable is fastened directly to the sensor casing without need for an additional cable connector. The sensor casing can therefore be formed shorter or take up less room than sensor casings known from the prior art, since no extra space is needed for a cable connector or the like and the number of electric contact points and the susceptibility to faults are reduced. The sensor directly connected to the sheathed cable thus constitutes a sheathed sensor cable.

In a preferred embodiment the sensor device is multi-part and comprises a measuring body spaced apart from an electronic measuring unit and connected thereto by electric connecting cores, wherein the conductors of the sheathed cable are firmly connected to the electronic measuring unit.

The sensor device can especially be a sensor cell.

Advantageously, the sensor casing portion comprising the cable insertion opening is a crimpable insertion sleeve and engages over the end of the sheathed cable on the sensor side.

Preferably the sensor casing and the integrally-moulded crimpable insertion sleeve are formed of brass.

Alternatively the sheathed cable can be fastened in tension-resistant manner to the sensor casing by a separate crimp barrel.

Preferably, the sensor casing, on or in the region of the cable insertion opening, has a collar with a web which engages behind the crimp barrel, at least in the state when crimped.

Advantageously, the sensor casing and the crimp barrel are formed of brass.

Preferably the plug or socket connecting element is fastened in sealing-tight manner to the sensor casing by a screwable fixing ring, which especially can be a screw cap.

Advantageously also in accordance with the invention, the sheathed cable also has an electric connecting plug at its free end. The plug can in principle be any connecting plug used in underground mining, for example a Hirschmann or OS4 plug or the like.

Advantageously also a multi-core cable comprising the conductors and with insulation can be provided in the sheath of the sheathed cable and in an advantageous construction projects at the free end of the sheath from a socket and receiving the sheath in tension-resistant manner, whereas at its cable end it has an electric connecting plug.

Alternatively a cable connector can be fastened to the other end of the sheathed cable and comprise a one-part hollow coupling sleeve which extends over the protective sheath and receives the end of the sheathed cable in tension-resistant manner in a compression joint, especially by crimping, and is connected thereto via a catch connection to a plug insert and receiving or comprising contact elements electrically connected to the conductors and preferably comprising pins and sockets, wherein a cable feed-through opening in the hollow coupling sleeve is partly filled with sealing compound and the coupling sleeve has an extension which is deformable in order to make the compression joint and exclusively holds the sheathed cable and the conductors surrounded by the insulated cable.

In an especially preferred embodiment the sensor device comprises a pressure sensor and the receiving connection on the underground device is a hydraulic connection, so that the sensor and the sheathed sensor cable together form a pressure sensor.

Alternatively the sensor device can be a temperature sensor or the like.

Example embodiments of sensors made in accordance with the present invention will now be explained with reference to the accompanying drawings, in which:

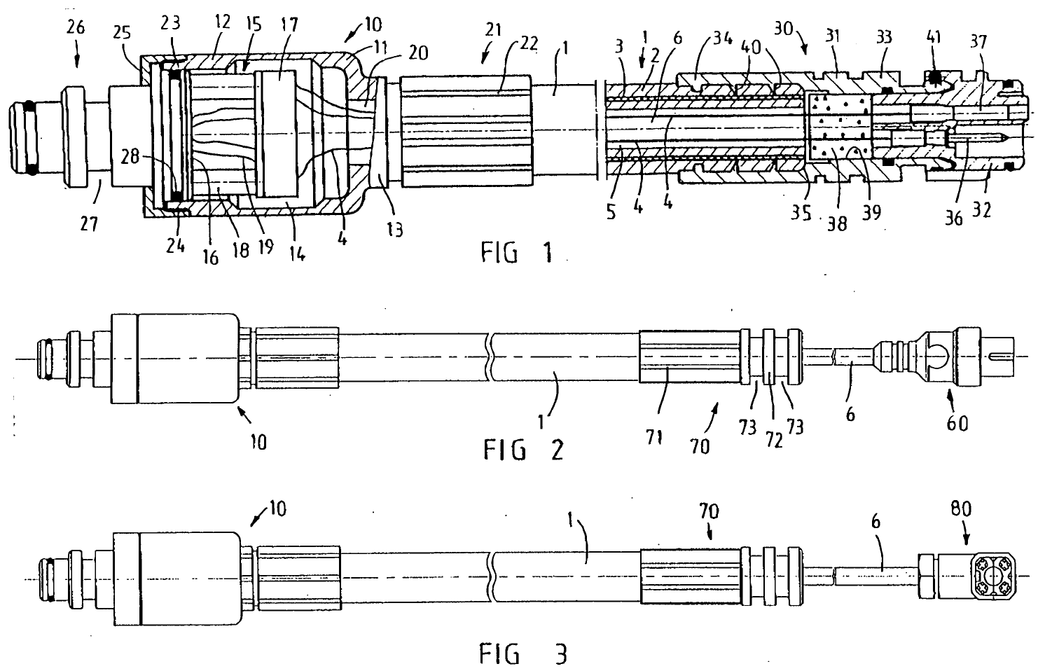

FIG. 1 shows a partial sectional view of a sheathed sensor cable in accordance with a first example embodiment;

FIG. 2 shows a sheathed sensor cable in accordance with a second example embodiment; and

FIG. 3 shows a sheathed sensor cable in accordance with a third embodiment.

The drawings show a sheathed cable 1 which is conventionally used in underground mining and comprises an outer protective covering or sheath 2 with preferably incorporated armouring 3, wherein a number of electric conductors 4 are protected inside the armouring 3 and extend in the hollow core of the sheath 2 and are preferably themselves surrounded by insulation or are bonded in a cable 6 with insulation 5. The basic structure of a said sheathed cable for use in underground mining is known, so that no further explanation will be given here.

The sheathed cable 1 shown in part in FIG. 1 has an electric coupler plug 30, for example for coupling to an individual electronic control unit, at one end (on the right in FIG. 1) whereas at its left end a sensor 10 is firmly and non-releasably connected to the cable 1, the overall result being a sheathed sensor cable which is immediately ready for use and can be directly connected between the underground device and an evaluating device.

The sensor 10 comprises a hollow casing 11 of brass, comprising a larger-diameter front hollow portion 12 followed by a smaller-diameter integrally moulded portion 13. In the interior 14 of the front portion 12 is a protected sensor device 15, which in the example embodiment shown is a pressure pick-up or pressure sensor. The sensor device 15 in this case is in a number of parts and comprises a measuring body 16 such as a DMS strain gauge or a diagrammatically indicated electronic measuring unit 17, which can be disposed for example on a circuit board and comprises an amplifier circuit and an auxiliary electronic unit. The electronic unit 17 is separated from the measuring body 16 by a spacer sleeve 18 and electrically connected thereto by electric connecting cores 19, so that the measurement signals received by the measuring body 16 and converted into electric signals can be supplied by the electronic unit 17 through the sheathed cable 1 to another evaluating device (not shown) such as an electronic control unit for shield-type shaft-lining supports. To this end the rear portion 13 of the sensor casing 11 comprises a cable insertion opening 20 through which the conductors 4 of the cable 1 are firmly and non-releasably connected to the electronic measuring unit 17 of the sensor device 15. The rear portion 13 of the sensor casing comprising the cable insertion opening 20 also constitutes a fastening means for firmly attaching the cable 1 to the sensor casing 11 or to the sensor 10. In the example embodiment shown, a brass insertion or crimp barrel 21 comprising the cable insertion opening 20 is integrally formed on the rear portion 10 of the sensor casing 11 and can be crimped as indicated by longitudinal slots 22 and enable the sheathed cable 1 in the crimp barrel 21 to be secured in tension-resistant manner by crimping or compressing.

The front end of the front portion 12 of the sensor casing 11 has an axial extension 23 which at its outer periphery has an outer screwthread 24 for screwing on a fixing ring 25 in the form of a screw cap. By means of the ring 25, a connecting element 26, in the form of a socket in this case, is fastened to the sensor casing 11 and is insertable into a receiving connection on the underground device (not shown) and is secured there in conventional manner in underground mining, by a U-shaped plug-in fork which engages in a peripheral annular groove 27 on the connecting element 26. In the case of a pressure sensor the connecting element 26 is formed with a bore (not shown) through which the measuring body 16, which rests on the back of the connecting element 26 when assembled, is in contact with the hydraulic medium and consequently with the measured variable or variable of state. An additional seal in the form of an O-ring 28 is inserted into a peripheral groove on the connecting element 26, which when assembled abuts the inner periphery of the front portion 12 of the sensor casing 11.

The right half of FIG. 1 shows a cable connector 30 fastened in tension-resistant manner to the other end of the sheathed cable and comprising a brass coupling sleeve 31 connected by a catch connection to a plug insert 32. The catch connection is secured by one or more peripherally disposed metal snap-in balls 41 or plastics material catch elements disposed on the overlapping regions of the plug insert 32 and the coupling sleeve 31. The hollow coupling sleeve 31 ends in a coupling portion 33 which receives the plug insert 32 and is integrally connected to an extension 34 in which the end of the sheathed cable, the sheath 1, armour 3, insulated cable 6 and conductors 4 are so inserted that only the conductors 4, if required together with their insulating cover, project beyond an inner shoulder 35 on the foot of the sleeve extension 34 and at the transition to the coupling portion 33. The conductors 4 are firmly connected by contact pins 36 or complementary-shaped contact sockets 37 in the form of complementary contact elements in the plug insert 32, in order to make an electrical connection to identically shaped contact elements formed in sockets on an electronic control unit or the like. A filler member 38 made of sealing compound is formed between the back of the contact elements and the end of the protective sheath abutting the shoulder 35 and is used for withstanding tensile forces and fixing the contacts and prevents moisture flowing through the hollow cable passage opening 39 inside the sleeve 31 of the cable connector 30. After the conductors 4 have been fitted on the contact elements 36, 37 and the sealing compound 38 has been introduced, the sleeve extension 34 is compressed for example by a suitable crimping tool so that projections 40 on the inner periphery of the extension 34 press into the sheath 2 of the sheathed cable 1 and secure the cable sheath 1 in tension-resistant manner to the coupling sleeve 31 and consequently to the cable connector 30. As is shown in FIG. 1, the entire tension-resistant connection is obtained exclusively via the construction of the protective sheath 1 and by pressing or crimping the sleeve extension 34, without inserting any additional parts such as supporting sleeves or the like between the cable 6 and the armouring 3 or the sheath 2.

FIG. 2 shows an alternative example embodiment of a sensor cable in accordance with the invention with a fixed sensor 10 on one end of a sheathed cable 1. The sensor 10 is identical in structure with the example embodiment in FIG. 1. In contrast to the embodiment in FIG. 1, an electric connecting plug 60 is mounted on the other end of the sheathed cable and is fastened in tension-resistant manner to only one portion of the insulated cable 6 holding the conductors. A preset length of the portion projects from a tube holder 70, which receives the plug end of the cable 1 in tension-resistant manner. In the example embodiment shown, the tube holder 70 also has a crimpable sleeve portion 71 adjoining a holder end piece 72 which in the present case has two peripheral annular grooves 73 for positively securing the holder 70, for example by plug-in forks, to suitable parts of the installation, cable feed-throughs or the like. In the example embodiment in FIG. 2, a cable connector 60 with an axial arrangement of the contact elements is fastened to the end of the insulated cable 6 surrounding the conductor, the cable connector 60 being more particularly an OS4 cable connector.

In the embodiment in FIG. 3, in contrast to the embodiment in FIG. 2, the end of the insulated cable 6 is fastened to an electric connecting plug 80 which is a right-angle plug (a Hirschmann plug in the present case).

For a person skilled in the art, the above-mentioned description gives rise to a series of modification which fall within the scope of the attached claims. For example, the tension-resistant connection between the sheathed cable and the sensor casing can also be formed by a separate crimp barrel, which is slid over a portion of the sensor casing so that an inner ring or annular collar on the barrel engages behind the casing portion in the neighbourhood of the cable insertion opening, when the crimp barrel is compressed and engages in the sheath of the sheathed cable.

1. A sensor for devices such as mining machines, shaft-lining supports or extracting plants in underground mining, comprising a sensor device disposed in a casing and scanning measurements or variables and converting them into electric signals, also comprising a connecting element in the form of a plug or socket fixed to the sensor casing and adapted to be coupled to a receiving connection on the device and through which the sensor device is supplied with the measurement or variable, and also comprising a flexible sheathed cable comprising conductors and a sheath, the sensor device being electrically connectable via the conductors to an evaluating device, in which the sensor casing comprises a portion with a cable insertion opening to which the sheathed cable is fastened in tension-resistant manner, wherein the conductors are firmly connected through the cable insertion opening to the sensor device.

2. A sensor according to claim 1, in which the sensor device is multi-part and comprises a measuring body spaced apart from an electronic measuring unit, and connected thereto by electric connecting conductors, wherein the cores are firmly connected to the electronic unit.

3. A sensor according to claim 1, in which the sensor device is a sensor cell.

4. A sensor according to claim 1, in which the casing portion comprising the cable insertion opening is a crimpable insertion sleeve and engages over the sheathed cable on the sensor side.

5. A sensor according to claim 4, in which the sensor casing and the integrally moulded insertion sleeve are formed of brass.

6. A sensor according to claim 1, in which the sheathed cable is connected in tension-resistant manner to the sensor casing by a crimp barrel.

7. A sensor according to claim 6, in which the sensor casing, on or in the region of the cable insertion opening, has a collar with a web which engages behind the crimp barrel.

8. A sensor according to claim 6, in which the sensor casing and the crimp barrel are formed of brass.

9. A sensor according to claim 1, in which the connecting element is fixed to the sensor casing by a screwable fixing ring.

10. A sensor according to claim 1, in which the sheathed cable has an electric connecting plug at its free end.

11. A sensor according to claim 10, in which a multi-core cable comprising the conductors and with insulation is provided in the sheath of the cable and projects at the free end of the sheath from a socket sealed by an O-ring and receiving the sheath in tension-resistant manner whereas at its cable end it has an electric connecting plug.

12. A sensor according to claim 1, in which a cable connector is fastened to the other end of the sheathed cable and comprises a one-part hollow coupling sleeve which extends over an armoured protective sheath and receives the end of the sheathed cable in tension-resistant manner in a compression joint, especially by crimping, and is connected via a catch connection to a plug insert which receives contact elements electrically connected to the conductors and preferably comprising pins and sockets, wherein a cable feed-through opening in the hollow coupling sleeve is partly filled with sealing compound and the coupling sleeve has an extension which is deformable in order to form the compression joint and exclusively holds only the protective cable and sheath and armouring and the conductors disposed in the cable.
